(19) United States
(12) Patent Application Publication
(10) Pub. No.: US 2020/0130596 A1
(43) Pub. Date: Apr. 30, 2020

(54) HOOK APPARATUS

(71) Applicant: NEWFREY LLC, New Britain, CT (US)

(72) Inventors: Masashi DENDO, Toyohashi-shi (JP); Tomonori ITO, Okazaki-shi (JP)

(21) Appl. No.: 16/669,983

(22) Filed: Oct. 31, 2019

(30) Foreign Application Priority Data
Oct. 31, 2018 (JP) 2018-204809

(51) Int. Cl. B60R 7/08; F16B 45/02

(52) U.S. Cl. CPC B60R 7/08; F16B 45/02

(57) ABSTRACT

A hook apparatus comprises a base attachable to the opening of a member-to-be-attached workpiece and a hook rotatably attached to the base. The base has a shaft holding portion on a side surface so as to hold the hook. The hook has a hook portion for holding a load, and a hook shaft portion held by the shaft holding portion of the base. The hook is pivotable on the hook shaft portion as a central axis between a storage position stored in the base and a use position where the hook portion is exposed to hold the load. The hook is further equipped with a locking portion support surface, and a workpiece abutting portion which abuts the back side of the workpiece above the opening of the workpiece when the hook is in the use position.

### CROSS-REFERENCE TO RELATED APPLICATION

This application claims priority from Japanese Patent Application No. 2018-204809, filed on Oct. 31, 2018, the entire disclosure of which is incorporated herein by reference.

### BACKGROUND OF THE INVENTION

The present invention relates to a hook apparatus that is provided in a passenger compartment of a vehicle, and that can suspend a load or the like.

When used as equipped with a base and a hook rotatably supported by the base, the hook apparatus provided in the passenger compartment and the like is capable of hanging luggage having a gripping portion such as a shopping bag or a bag, and the like, by extending the hook to a position for use. When not in use, the hook can be stored in the storage position.

In this regard, as in Patent Documents 1 and 2, hook apparatuses that are attached to a vehicle or the like have been developed. In Patent Document 1, when a housing is attached to a vehicle body panel with an elastic piece, when a load is applied, the edge of the panel hole is crushed and a gap is formed, which can become loose. Further, since there is a space behind the elastic piece, the elastic piece is bent and easily detached.

In Patent Document 2, while supporting the load applied to the hook apparatus on the upper side through the hooking piece of the base member, the elastic piece is attached below the opening of the member to be attached, the elastic piece is deformed with time, and the hole angle of the attached member is crushed and becomes loose.

As described above, a conventional hook apparatus is made of an elastic piece that is easily deformed when attached to the panel; if the elastic piece is deformed after long-term use, looseness occurs between the panel and the elastic piece. Moreover, when hooking an elastic piece on the edge of a panel hole, if it attaches to a resin panel, the edge will be crushed, and looseness will occur. Moreover, since the elastic piece may be impacted by load from the hook, it is necessary to ensure the rigidity of the elastic piece, and the amount of assembly load applied to the panel increases.

Patent Document 1 Japanese Unexamined Patent Application Publication No. 2003-325267.

Patent Document 2 WO2014/199768.

### BRIEF SUMMARY OF THE INVENTION

The object of the present invention is therefore to provide a hook apparatus equipped with a hook that can be attached to a panel and rotated and stored, that can be easily attached to the panel, that is not easily deformed or experiences looseness even after long-term use, and that can withstand greater loads.

To achieve this object, one aspect of the present invention is a hook apparatus, equipped with a base attached to an opening of a member to be attached, and a hook rotatably attached to the base; wherein the base has a shaft holding portion on a side surface so as to hold the hook; the hook has a hook portion for holding a load, and a hook shaft portion held by the shaft holding portion of the base; the portion between the storage position stored in the base and a usage position where the hook portion can be taken out to hold a load is rotatable with the hook shaft portion as a central axis; the hook is further provided with a member to be attached contact portion; and the member to be attached contact portion abuts the back side of the member to be attached above the opening of the member to be attached when the hook is in the use position.

With the hook apparatus, preferably when the hook is in the use position, the member to be attached contact portion abuts the back side of the member to be attached above the attachment position to the member to be attached of the base.

With the hook apparatus, preferably when the hook is in the use position and holds a load on the hook portion, the member to be attached contact portion is configured to apply a load on the back surface of the member to be attached.

Another aspect of the present invention is a hook apparatus equipped with a base attached to the opening of a member to be attached, and a hook rotatably attached to the base; wherein the base has a locking portion for locking with the member to be attached at an upper end of the opening of the member to be attached, and a shaft holding portion formed on a side surface to hold the hook; the hook has a hook portion for holding a load and a hook shaft portion held by the shaft holding portion of the base; the area between a storage position stored in the base and a use position where the hook portion can be taken out to hold a load is pivotable with the hook shaft portion as a central axis; the hook is further equipped with a locking portion support surface, and the locking portion support surface supports the locking portion of the base from below when the hook is in the use position.

The hook apparatus is preferably configured so that when the hook is in the storage position, a flex space exists between the locking portion of the base and the hook; when the hook is in the use position, there is no bending space between the locking portion of the base and the locking portion support surface of the hook.

The hook apparatus is preferably configured so that the base has a flange on a front surface of the base, and the member to be attached is attached between an upper portion of the flange and the locking portion.

According to the present invention, a hook apparatus provided with a hook that is attached to a panel and can be rotated and stored can be easily attached to the panel, is hardly deformed with no looseness generated even after long-term use, and can withstand a greater load.

### BRIEF DESCRIPTION OF THE SEVERAL VIEWS OF THE DRAWINGS

FIG. 1 is a perspective view of a hook of a hook apparatus according to an embodiment of the present invention.

FIG. 2 is a perspective view of the hook of the hook apparatus according to the embodiment of the present invention as seen from another direction.

FIG. 3 is a front view of the hook of FIGS. 1 and 2.

FIG. 4 is a right-side view of the hook of FIGS. 1 and 2.

FIG. 5 is a perspective view of the base of the hook apparatus according to an embodiment of the present invention.

FIG. 6 is a perspective view of the base of the hook apparatus according to an embodiment of the present invention viewed from another direction.

FIG. 7 is a front view of the base of FIGS. 5 and 6.

FIG. 8 is a right-side view of the base of FIGS. 5 and 6.

FIG. 9 is a perspective view of the hook apparatus according to an embodiment of the present invention in a state in which the hook is housed in the base.

FIG. 10 is a perspective view of the hook apparatus according to an embodiment of the present invention as seen from another direction in which the hook is housed in the base.

FIG. 11 is a front view of the hook apparatus of FIGS. 9 and 10.

FIG. 12 is a right-side view of the hook apparatus of FIGS. 9 and 10.

FIG. 13 is a cross-sectional view taken along line A-A of the hook apparatus of FIG. 11.

FIG. 14 is a cross-sectional view taken along line B-B of the hook apparatus of FIG. 11.

FIG. 15 is a cross-sectional view taken along line C-C of the hook apparatus of FIG. 12.

FIG. 16 is a perspective view of the hook apparatus according to an embodiment of the present invention with the hook opened.

FIG. 17 is a perspective view of the hook apparatus according to an embodiment of the present invention as seen from another direction with the hook opened.

FIG. 18 is a front view of the hook apparatus of FIGS. 16 and 17.

FIG. 19 is a right-side view of the hook apparatus of FIGS. 16 and 17.

FIG. 20 is a cross-sectional view taken along line E-E of the hook apparatus of FIGS. 16 and 17.

FIG. 21 is a cross-sectional view taken along line F-F of the hook apparatus of FIGS. 16 and 17.

FIG. 22 is a cross-sectional view taken along line G-G of the hook apparatus of FIGS. 16 and 17.

FIG. 23 is a view showing a state in the middle of attaching the hook apparatus according to an embodiment of the present invention to the panel to be attached.

FIG. 24 is a view showing a state in which the hook apparatus according to an embodiment of the present invention is attached to the panel to be attached.

### DETAILED DESCRIPTION OF PREFERRED EMBODIMENTS OF THE INVENTION

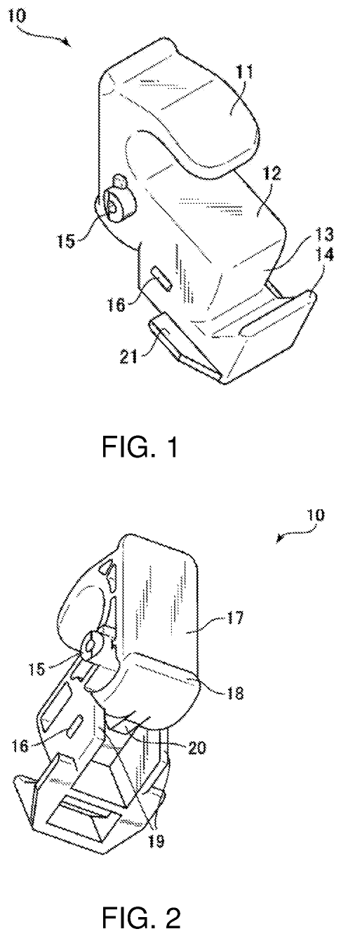

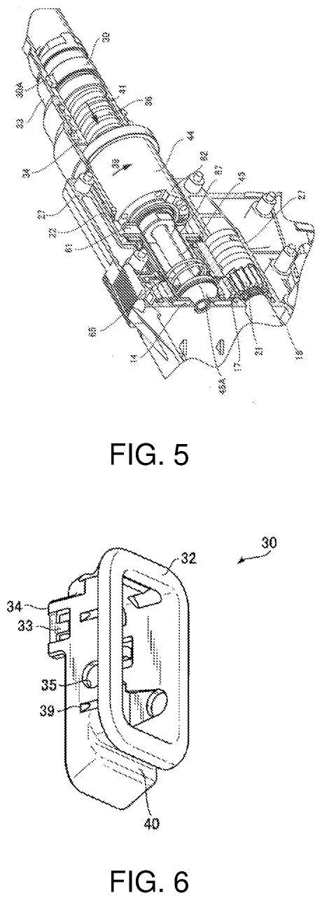

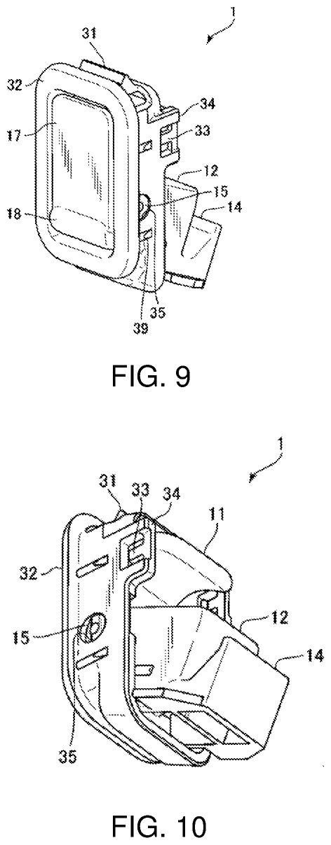

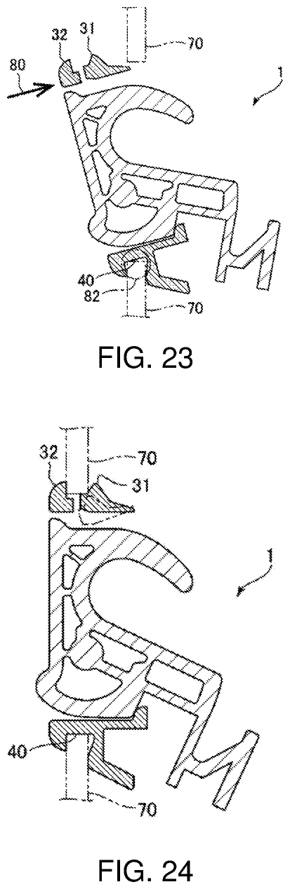

Hereinafter, embodiments of the present invention will be described with reference to the drawings. The hook apparatus according to the embodiment of the present invention consists of a hook 10 shown in FIGS. 1 to 4, and a base 30 shown in FIGS. 5 to 8. As shown in FIGS. 9 to 22, the hook 10 and the base 30 are combined to form the hook apparatus 1. As shown in FIGS. 23 and 24, the hook apparatus 1 is attached to a panel to be attached such as a vehicle body or a deck side trim. First, the hook 10 will be described, and then the base 30 will be described; after which the hook apparatus 1 in which the hook 10 and the base 30 are assembled will be described. In the present specification, the vertical direction refers to the vertical direction in the figures. The horizontal direction refers to the horizontal direction in the figures.

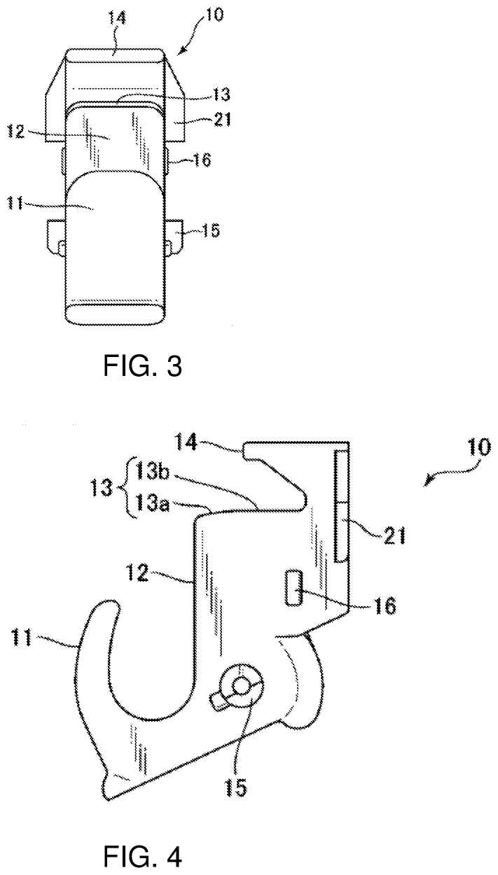

The hook 10 will be described with reference to FIGS. 1-4. FIG. 1 is a perspective view of a hook 10 of a hook apparatus according to an embodiment of the present invention. FIG. 2 is a perspective view of the hook 10 of the hook apparatus according to the embodiment of the present invention as seen from another direction. FIG. 3 is a front view of the hook 10 of FIGS. 1 and 2, and FIG. 4 is a right-side view of the hook 10 of FIGS. 1 and 2. The hook 10 is made of synthetic resin.

As shown in FIGS. 1 and 4, the hook 10 has a hook portion 11 and a base portion 12. The hook portion 11 is capable of hanging a handle portion of a load and the like between the base portion 12 and the hook portion 11. As shown in FIGS. 1 to 4, a pair of hook shaft portions 15 are formed on the left and right of the position below the center of the hook 10. The hook shaft portion 15 extends in the lateral direction. The hook shaft portion 15 is rotatably supported by a shaft holding portion 35 of the base 30 to be described later. In a state in which the hook 10 is incorporated in the base 30, the hook 10 is able to rotate between the storage position and the use position with the hook shaft portion 15 as an axis. The storage position is a state in which the hook 10 is stored in the base 30 (hook storage), and the use position is a state in which the hook portion 11 of the hook 10 is able to project into the vehicle compartment and hook a load or the like (hook open).

As shown in FIG. 4, a panel locking claw support surface (locking portion support surface) 13 is formed so as to extend substantially horizontally from the upper portion of the base portion 12. The panel locking claw support surface 13 has an inclined surface 13a on the hook portion 11 side on the base portion 12 and a horizontal surface 13b extending therefrom; when the hook 10 is moved from the storage position to the use position, the arrangement is such that the hook 10 is prevented from interfering with the lower end of a panel locking claw (locking portion) 31 of the base 30 described later, and at the use position of the hook 10, the panel locking claw 31 of the base 30 described later can be supported from below.

Further, as shown in FIG. 4, a panel contact portion (member to be attached contact portion) 14 is formed at the upper end portion of the hook 10; when the hook 10 is in the use position (when the hook is open), the panel abutting portion 14 abuts the attached panel, so that the hook itself can directly support the load applied to the hook 10.

Further, as shown in FIGS. 3 and 4, a hook rotation stopper 21 and a hook lock portion 16 for opening the hook are formed on the left and right sides of the base portion 12. The hook rotation stopper 21 functions as a stopper for preventing the hook portion 11 from rotating further from the use position where the hook portion 11 faces upward when the hook 10 is opened; in this state, the hook lock portion 16 locks the hook 10 to the base 30 so as not to move.

As shown in FIG. 2, the hook 10 has an exposed surface during storage 17 the front of which is substantially rectangular. The exposed surface during storage 17 is a portion that can be seen on the surface when the hook apparatus is mounted in a vehicle cabin or the like. A rectangular knob 18 that is long in the lateral direction is formed below the exposed surface during storage 17. The hook 10 can be opened to the use position by pressing the knob 18 by using a finger.

Also, as shown in FIG. 2, a hook rotation stopper 19 and a hook lock portion 20 for hook storage are formed. The hook rotation stopper 19 functions as a stopper to prevent further rotation from a position where the exposed surface during storage 17 is parallel to the surface of the flange 32 of the base 30 when the hook 10 is stored; in this state, the hook lock portion 20 locks the hook 10 to the base 30 so as not to move.

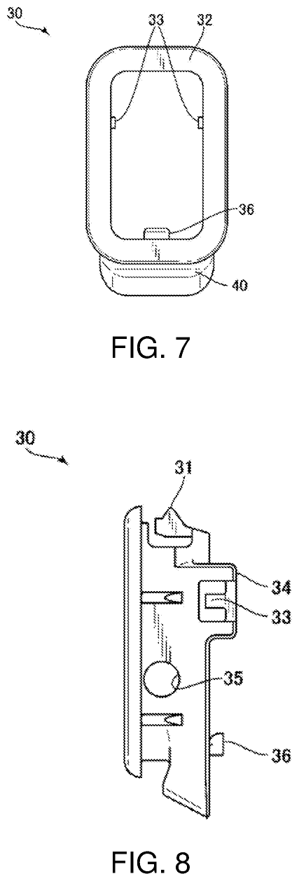

Next, the base 30 will be described with reference to FIGS. 5-8. The base 30 accommodates the hook 10 inside and holds the hook 10 so as to be rotatable. FIG. 5 is a perspective view of the base 30 of the hook apparatus according to the embodiment of the present invention. FIG. 6 is a perspective view of the base 30 of the hook apparatus according to the embodiment of the present invention as seen from another direction. FIG. 7 is a front view of the base 30 of FIGS. 5 and 6, and FIG. 8 is a right-side view of the base 30 of FIGS. 5 and 6. The base 30 is made of a synthetic resin like the hook 10.

As shown in FIG. 7, the base 30 has a substantially rectangular flange 32, and an opening is formed inside the flange 32. As shown in FIGS. 5 and 8, a panel locking claw 31 is formed on the upper portion of the base 30; when the base 30 is attached to the panel to be attached (member to be attached) 70, the panel locking claw 31 sandwiches the frame of the panel to be attached 70 in the interval with the flange 32 and holds it upward. Meanwhile, as shown in FIG. 6, a panel clamping portion 40 is formed at the lower portion of the base 30. When the base 30 is attached to the panel to be attached 70, the panel clamping unit 40 sandwiches the frame of the panel to be attached 70 in the interval with the flange 32.

As shown in FIG. 5, a pair of shaft holding portions 35 and a shaft portion fitting guide taper 38 is formed. The pair of shaft holding portions 35 fits the hook shaft portion 15 via the shaft portion fitting guide taper 38 and holds it rotatably.

As shown in FIG. 5, a base stopper 34 and a base lock claw 33 for opening the hook are formed. The base stopper 34 functions as a stopper wherein, by contacting the hook rotation stopper 21 of the hook 10 when the hook is opened, the hook portion 11 is prevented from further rotating from a position facing upward when the hook 10 is opened; in this state, the base lock claw 33 locks the hook 10 to the base 30 so as not to move by hooking the hook lock portion 16 of the hook 10.

As shown in FIG. 5, a base stopper 37 and a base lock claw 36 for hook storage are formed. By the base stopper 37 coming into contact with the hook rotation stopper 19 of the hook 10 when the hook is stored; at the time the hook 10 is stored, it functions as a stopper to prevent the exposed surface during storage 17 from rotating further from a position parallel to the surface of the flange 32 of the base 30, and the base lock claw 36 locks the hook 10 to the base 30 so as not to move by hooking the hook lock portion 20 of the hook 10 in this state.

Also, as shown in FIG. 5, ribs 39 are formed to prevent looseness along the surface with the panel.

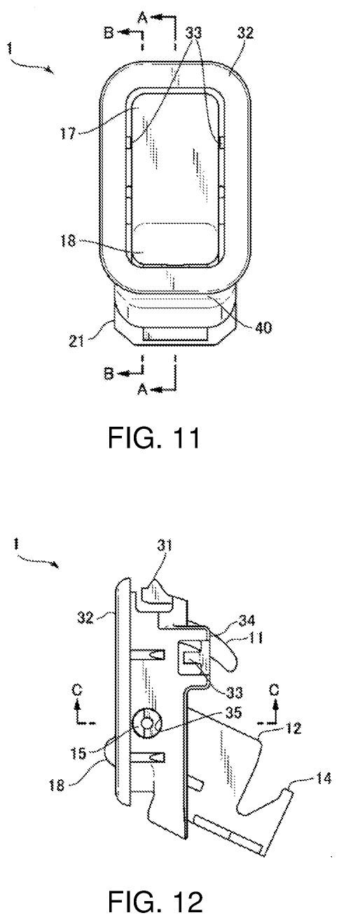

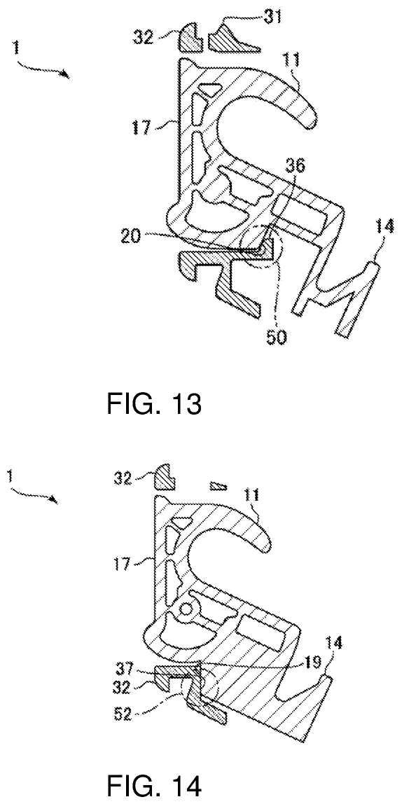

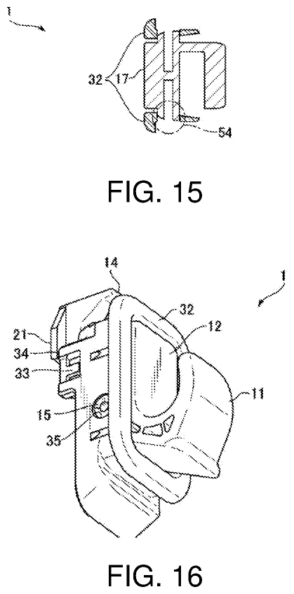

The hook apparatus is created by incorporating the hook 10 into the base 30. First, the hook storage state of the hook apparatus will be described with reference to FIGS. 9 to 15. FIG. 9 is a perspective view of the hook apparatus 1 according to the embodiment of the present invention with the hook 10 housed in the base 30. FIG. 10 is a perspective view of the hook apparatus 1 according to the embodiment of the present invention as seen from another direction in which the hook 10 is housed in the base 30. FIG. 11 is a front view of the hook apparatus 1 of FIGS. 9 and 10. FIG. 12 is a right-side view of the hook apparatus 1 of FIGS. 9 and 10. FIG. 13 is a cross-sectional view taken along line A-A of the hook apparatus of FIG. 11. FIG. 14 is a cross-sectional view taken along line B-B of the hook apparatus of FIG. 11. FIG. 15 is a cross-sectional view taken along line C-C of the hook apparatus of FIG. 12.

In a state in which the hook 10 is stored in the base 30, the hook shaft portion 15 of the hook 10 is rotatably supported by the shaft holding portion 35 of the base 30. Further, when the hook 10 is in the storage position, the exposed surface during storage 17 of the hook 10 and the surface of the flange 32 of the base 30 are substantially in the same plane, and the exposed surface during storage 17 is positioned at the opening inside the flange 32. Moreover, in this state, the knob 18 is raised from the plane formed by the exposed surface during storage 17 and the flange 32 at the time of storage; the hook 10 can be opened by pushing the knob 18 by using a finger. When the knob 18 of the hook 10 is pushed, the hook 10 rotates about the hook shaft portion 15 as a central axis, and the hook portion 11 of the hook 10 protrudes from the base 30.

As shown in FIG. 14, the hook apparatus 1 has a rotation stopper structure 52 provided to prevent the exposed surface during storage 17 from rotating from a position parallel to the surface of the flange 32 of the base 30 when the hook 10 is stored, by the contact of the base stopper 37 of the base 30 with the hook rotation stopper 19 of the hook 10 when the hook is stored.

As shown in FIG. 13, the hook apparatus 1 has a lock structure 50 that locks the hook 10 to the base 30 when the base lock claw 36 hooks the hook lock portion 20 of the hook 10 when the hook is stored.

Such a lock structure 50 allows the hook 10 to be held in the storage position until the knob 18 of the hook 10 is pushed and rotated, by using a finger, for subsequent use.

Further, as shown in FIG. 15, the hook apparatus 1 has a rotating shaft structure 54 wherein the pair of shaft holding portions 35 of the base 30 fits and holds the hook shaft portion 15 via the shaft portion fitting guide taper 38 so as to be rotatable.

Next, the hook open state of hook apparatus 1 will be described with reference to FIGS. 16 to 22.

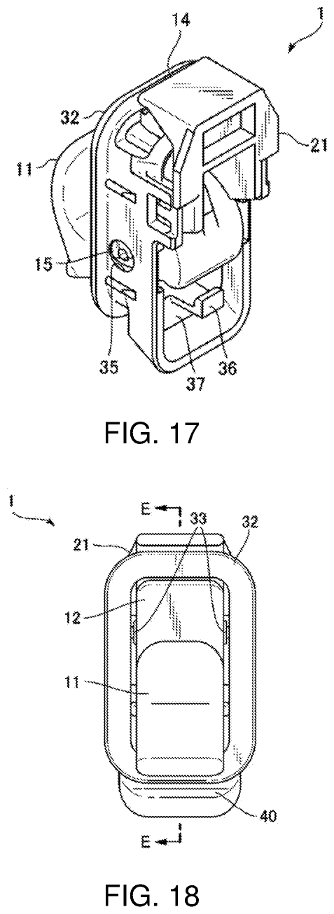

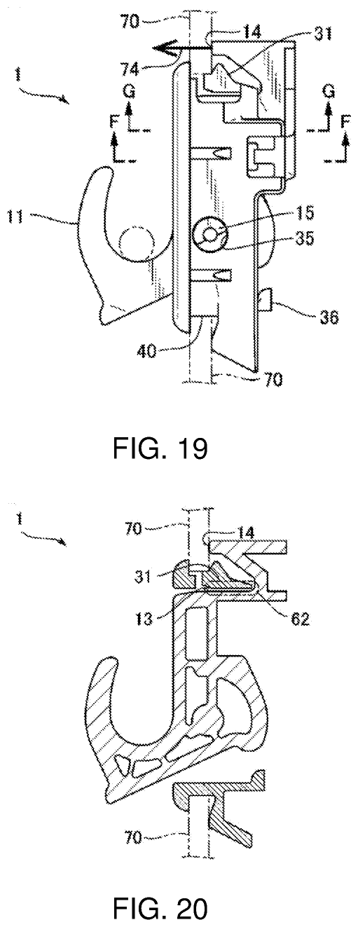

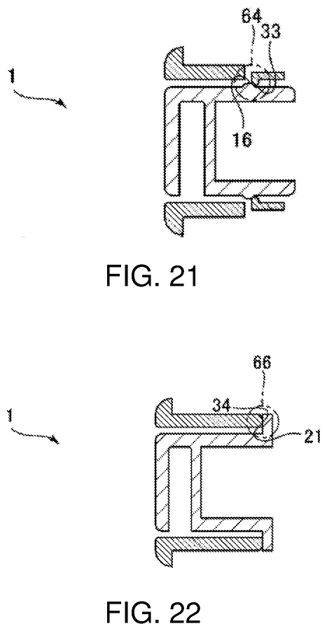

FIG. 16 is a perspective view of the hook apparatus according to an embodiment of the present invention with the hook opened. FIG. 17 is a perspective view of the hook apparatus according to an embodiment of the present invention as seen from another direction with the hook opened. FIG. 18 is a front view of the hook apparatus of FIGS. 16 and 17. FIG. 19 is a right-side view of the hook apparatus of FIGS. 16 and 17. FIG. 20 is a cross-sectional view taken along line E-E of the hook apparatus of FIGS. 16 and 17. FIG. 21 is a cross-sectional view taken along line F-F of the hook apparatus of FIGS. 16 and 17. FIG. 22 is a cross-sectional view taken along line G-G of the hook apparatus of FIGS. 16 and 17.

As FIG. 19 shows, the hook apparatus 1 is attached to the panel to be attached 70, and, when using a hook, the hook apparatus 1 takes a hook open state. In the hook open state, the hook apparatus 1 has a structure in which the hook itself can directly support the load applied to the hook by the panel abutting portion 14 of the hook 10 abutting the back side of the panel to be attached 70. Here, when the hook 10 is used and a load of a payload is applied to the hooking portion 11 of the hook 10 in FIG. 19, the panel contact portion 14 of the hood 10 is subjected to a force in a direction perpendicular to the back surface of the panel to be attached 70 (that is, a leftward force 74 in FIG. 19) due to the positional relationship with the hook shaft portion 15. In this regard, with the position of the panel to be attached 70 which the panel contact portion 14 of the hook 10 abuts above the panel locking claw 31 of the base 30, by designing the position upward and away from the opening of the panel to be attached 70, the load applied to the hook 10 can be directly supported by the hook itself, and the load applied to the panel locking claw 31 and the panel holding portion 40 of the base 30 can be reduced.

With such a structure, the load on the panel locking claw 31 of the base 30 can be reduced, the deformation over time can be suppressed, and looseness can be inhibited. Moreover, since the load with respect to the hook 10 is supported by the panel contact portion 14 which is a rigid body, even if an object of a certain weight is suspended from the hook portion 11 of the hook 10, it becomes possible to endure the load. Additionally, since the rigidity of the panel locking claw 31 of the base 30 can be reduced, the assembly load applied to the mounted panel 70 can be decreased.

Further, even if the mounted panel 70 consists of a soft material, such as a resin panel and the like, it can be made difficult to come off, since it is supported at a position separated from the opening portion of the panel to be attached 70.

Also, support is provided in a position separated from the opening portion of the panel to be attached 70, so that deformation of the panel to be attached 70 by the pressing force of the panel contact portion 14 can be prevented.

As shown in FIG. 20, in the hook open state, the hook apparatus 1 has a structure 62 that eliminates the bending space, as the panel locking claw support surface 13 of the hook 10 is close to the lower end of the panel locking claw 31 of the base 30. In the structure 62, when the panel locking claw 31 starts to bend in the hook open state, the lower end of the panel locking claw 31 comes into contact with the panel locking claw support surface 13. With such a structure 62, when a load is hung on the hook portion 11, the panel locking claw support surface 13 of the hook 10 supports the panel locking claw 31 of the base 30 from below, so that the panel locking claw 31 can be reinforced.

With such a structure 62, it is possible to increase the removal load from the panel to be attached 70. Moreover, the rigidity of the panel latching claw 31 can be reduced, and the assembly load applied to the panel to be attached 70 can be decreased.

As shown in FIG. 21, in the hook open state, the hook apparatus 1 has a structure 64 for locking the hook 10 to the base 30 so that the base lock claw 33 of the base 30 does not move by hooking the hook lock portion 16 of the hook 10.

As shown in FIG. 22, in the hook open state, the hook apparatus 1 has a structure 66 that prevents the hook portion 11 from rotating from a position facing upward when the hook 10 is opened, by the base stopper 34 coming into contact with the hook rotation stopper 21 of the hook 10.

FIG. 23 is a view showing a state in the middle of attaching the hook apparatus 1 according to an embodiment of the present invention to the panel to be attached 70; FIG. 24 shows the attached state thereafter. As shown in FIG. 23, first, an operation 82 for hooking the panel clamping portion 40 of the base 30 to the panel to be attached 70 is performed; next, an operation 80 is performed in which the panel locking claw 31 and the flange 32 are pushed into the panel to be attached 70 so that the frame of the panel to be mounted 70 is sandwiched between the panel locking claw 31 and the flange 32 of the base 30.

When the hook apparatus 1 is attached to the panel to be attached 70 by sandwiching the frame of the panel to be attached 70 between the panel locking claw 31 and the flange 32 of the base 30, as shown in FIG. 24, when the hook 10 is stored in the base 30, there is a bending space for the panel locking claw 31. As described above, the configuration is such that, in the state where the hook 10 is in the use position (hook open state), this bending space is eliminated when the panel locking claw support surface 13 of the hook 10 comes close to the panel locking claw 31 of the base 30.

According to an embodiment of the present invention, with a hook apparatus provided with a hook that can be attached to a panel and rotated and stored, it is possible to provide a hook apparatus that can be easily attached to a panel, is less likely to be deformed or experience looseness even after long-term use, and can withstand greater loads.

Embodiments and working examples of the hook apparatus according to the present invention have been described above; however, it will be easily understood that the present invention is not limited to the above-described embodiments, and various modifications can be made thereto. In addition, as long as they are within the scope of matters described in the respective claims and equivalent matters, they are naturally included in the technical scope of the present invention. The above working examples are intended to be mounted on a vehicle or the like, but this is only an example, and the present invention is not limited to this specific example.

It will be appreciated by persons skilled in the art that the above embodiments have been described by way of example only, and not in any limitative sense, and that various alterations and modifications are possible without departure from the scope of the invention as defined by the appended claims.

### DESCRIPTION OF REFERENCE NUMERALS

1 Hook apparatus
10 Hook
11 Hooking portion
12 Base
13 Panel locking claw support surface
13a Inclined surface
13b Horizontal surface
14 Panel contact portion
15 Hook shaft portion
16 Hook lock portion
17 Exposed surface during storage
18 Knob
19 Hook rotation stopper
20 Hook lock portion
21 Hook rotation stopper
30 Base
31 Panel locking claw
32 Flange
33 36 Base lock claw
34 37 Base stopper
35 Axis holding portion
38 Axis portion fit guide taper
39 Rib
40 Panel clamping portion
50 Lock structure
54 Rotation shaft structure
70 Panel to be attached

What is claimed is:

1. A hook apparatus for holding a load and attachable in an opening partially defined by a workpiece member to be attached, the member to be attached having a near side and a back side, and the hook apparatus comprising:
a base attachable to the opening of the member to be attached, and the base has a shaft holding portion formed on a side surface; and
a hook rotatably attached to the base by the shaft holding portion as a central axis, the hook pivotable between a storage position stored in the base and a use position where the hook can hold the load, and the hook includes:
a hook portion for holding the load when in the use position;
a hook shaft portion held by the shaft holding portion of the base;
a locking portion support surface; and
a member to be attached abutting portion which abuts the back side of the member to be attached above the opening in the member to be attached when the hook is in the use position.

2. The hook apparatus according to claim 1, wherein the member to be attached abutting portion abuts the back side of the member to be attached above the attachment position to the member to be attached of the base when the hook is in the use position.

3. A hook apparatus for holding a load is attachable to an opening of a member to be attached and the hook apparatus comprises:
a base attachable to the opening of the member to be attached;
a hook rotatably attached to the base;
wherein the base includes a locking portion for engaging with the member to be attached at an upper end portion of the opening of the member to be attached, and a shaft holding portion formed on a side surface to hold the hook;
the hook includes a hook portion for holding the load, and a hook shaft portion held by the shaft holding portion of the base; the area between a storage position stored in the base and a use position where the hook portion can be taken out to hold a load is pivotable with the hook shaft portion as a central axis; and
the hook further includes a locking portion support surface; and the locking portion support surface supports the locking portion of the base from below when the hook is in the use position.

4. The hook apparatus according to claim 3, wherein when the hook is in the storage position, there is a bending space between the locking portion of the base and the hook, and when the hook is in the use position, there is no bending space between the locking portion of the base and the locking portion support surface of the hook.

5. The hook apparatus according to claim 3, wherein the base includes a flange on a front surface of the base, configured to attach the member to be attached between the top of the flange and the locking portion.
